(19) United States
(12) Patent Application Publication
(10) Pub. No.: US 2026/0064381 A1
(43) Pub. Date: Mar. 5, 2026

(54) SYSTEM AND METHOD FOR USE WITH A DATA ANALYTICS ENVIRONMENT TO PROVIDE AN AI-BASED ASSISTANT FOR USE IN SOFTWARE DEVELOPMENT

(71) Applicant: ORACLE INTERNATIONAL CORPORATION, Redwood Shores, CA (US)

(72) Inventors: Chandra Sekhar Yalla, Hyderabad (IN); Mayank Bansal, Bengaluru (IN); Bhopal Singh, Bengaluru (IN); Vikash Singh, Bengaluru (IN); Abhijit C V, Bengaluru (IN)

(21) Appl. No.: 19/185,029

(22) Filed: Apr. 21, 2025

Related U.S. Application Data
(60) Provisional application No. 63/690,581, filed on Sep. 4, 2024.

(51) Int. Cl. G06F 8/35

(52) U.S. Cl. CPC G06F 8/35

(57) ABSTRACT

Embodiments described herein are generally related to data analytics environments, and are particularly directed to systems and methods for use with a data analytics environment to provide an AI-based assistant for use in software development. In accordance with an embodiment, an exemplary method can provide access to a data analytics environment by a computer including one or more processors. The method can provide a first agent operating on the computer, wherein the first agent monitors an application running at an application server. The method can provide a second agent operating on the computer, wherein the second agent comprises a connection to one or more large language models. The method can, upon detection by the first agent, of an error or exception associated with the application running at the application server, utilize, by the second agent, the LLM to generate a fix responsive to the detected error or exception.

### CLAIM OF PRIORITY AND CROSS-REFERENCE TO RELATED APPLICATIONS

This application claims the benefit of priority to U.S. Provisional Patent Application titled “SYSTEM AND METHOD FOR USE WITH A DATA ANALYTICS ENVIRONMENT TO PROVIDE AN AI-BASED ASSISTANT FOR USE IN SOFTWARE DEVELOPMENT”, Application No. 63/690,581, filed Sep. 4, 2024; which above application and the contents thereof are herein incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

Embodiments described herein are generally related to data analytics environments, and are particularly directed to systems and methods for use with a data analytics environment to provide an AI-based assistant for use in software development.

### BACKGROUND

Generally described, data analytics enables the computer-based examination of an amount of data, to derive an analytic data, metrics, conclusions, or other types of analytical information from, or descriptive of, the source data. Systems and methods can be used, for example, to generate an analytic business intelligence data, such as a set of data metrics or measures operating as key performance indicators, which analytically describe an organization's business-related data in a format useful to its decision-makers.

### SUMMARY

Embodiments described herein are generally related to data analytics environments, and are particularly directed to systems and methods for use with a data analytics environment to provide an AI-based assistant for use in software development.

In accordance with an embodiment, an exemplary method can provide access to a data analytics environment by a computer including one or more processors. The method can provide a first agent operating on the computer, wherein the first agent monitors an application running at an application server. The method can provide a second agent operating on the computer, wherein the second agent comprises a connection to one or more large language models. The method can, upon detection by the first agent, of an error or exception associated with the application running at the application server, utilize, by the second agent, the LLM to generate a fix responsive to the detected error or exception.

### BRIEF DESCRIPTION OF THE DRAWINGS

FIG. 1 illustrates a system for providing a cloud infrastructure or data analytics environment, in accordance with an embodiment.

FIG. 2 further illustrates a system for providing a cloud infrastructure or data analytics environment, in accordance with an embodiment.

FIG. 3 illustrates an example use of the system to provide a data analytics environment, in accordance with an embodiment.

FIG. 4 further illustrates an example data analytics environment, in accordance with an embodiment.

FIG. 5 further illustrates an example data analytics environment, in accordance with an embodiment.

FIG. 6 further illustrates an example data analytics environment, in accordance with an embodiment.

FIG. 7 further illustrates an example data analytics environment, in accordance with an embodiment.

FIG. 8 further illustrates an example data analytics environment, in accordance with an embodiment.

FIG. 9 further illustrates an example data analytics environment, including the use of a large language model, in accordance with an embodiment.

FIG. 10 further illustrates an example data analytics environment, including the use of retrieval-augmented generation, in accordance with an embodiment.

FIG. 11 illustrates a flowchart for use with a data analytics environment to provide an AI-based assistant for use in software development, in accordance with an embodiment.

FIG. 12 illustrates a system for use with a data analytics environment to provide an AI-based assistant for use in software development, in accordance with an embodiment.

FIG. 13 illustrates a screenshot produced by a system for use with a data analytics environment to provide an AI-based assistant for use in software development, in accordance with an embodiment.

FIG. 14 illustrates a screenshot produced by a system for use with a data analytics environment to provide an AI-based assistant for use in software development, in accordance with an embodiment.

FIG. 15 illustrates a screenshot produced by a system for use with a data analytics environment to provide an AI-based assistant for use in software development, in accordance with an embodiment.

FIG. 16 illustrates a flowchart of a method for use with a data analytics environment to provide an AI-based assistant for use in software development, in accordance with an embodiment.

### DETAILED DESCRIPTION

Generally described, within an organization, data analytics enables computer-based examination of large amounts of data, for example to derive conclusions or other information from the data. For example, business intelligence (BI) tools can be used to provide users with business intelligence describing their enterprise data, in a format that enables the users to make strategic business decisions.

Increasingly, data analytics can be provided within the context of enterprise software application environments, such as, for example, an Oracle Fusion Applications environment; or within the context of software-as-a-service (SaaS) or cloud environments, such as, for example, an Oracle Analytics Cloud or Oracle Cloud Infrastructure environment; or other types of analytics application or cloud environments.

Examples of data analytics environments and business intelligence tools/servers include Oracle Business Intelligence Server (OBIS), Oracle Analytics Cloud (OAC), and Fusion Analytics Warehouse (FAW), which support features such as data mining or analytics, and analytic applications.

### Cloud Infrastructure Environments

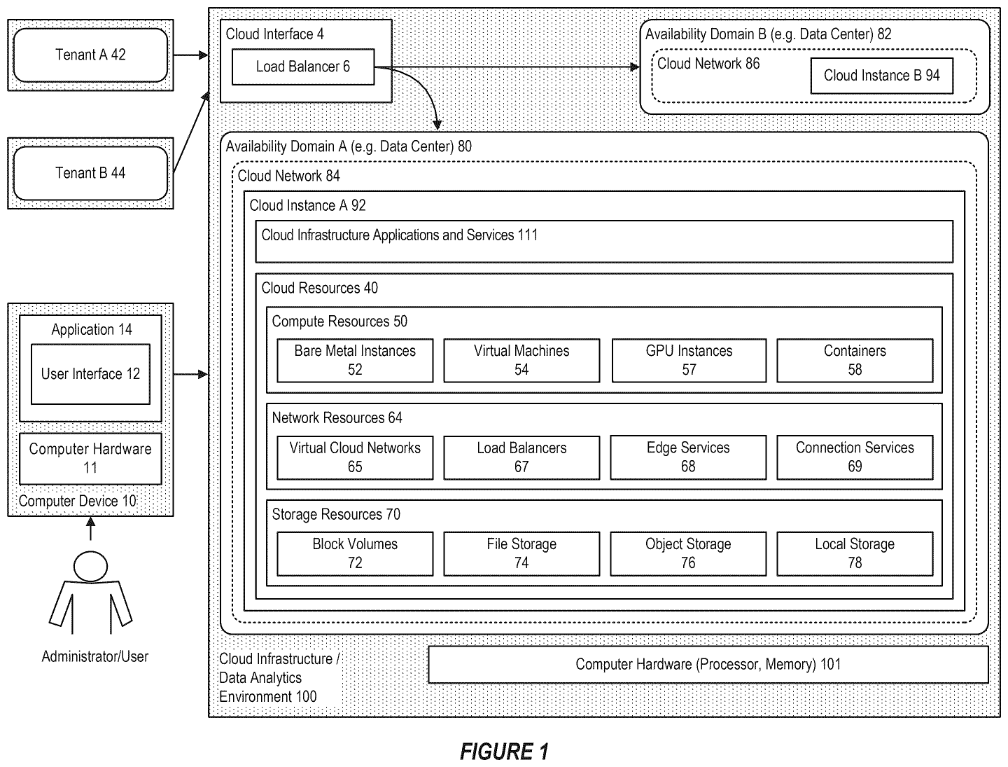

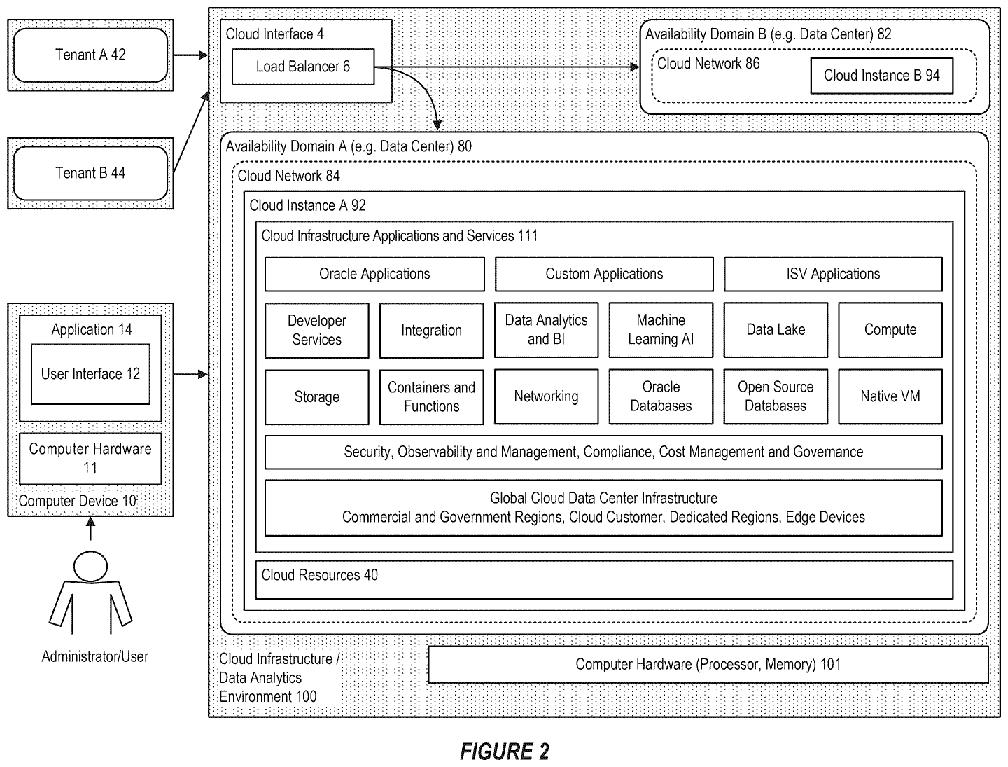

FIGS. 1 and 2 illustrate a system for providing a cloud infrastructure or data analytics environment, in accordance with an embodiment.

In accordance with an embodiment, the components and processes illustrated in FIG. 1, and as further described herein with regard to various embodiments, can be provided as software or program code executable by a computer system or other type of processing device, for example a cloud computing system, or other suitably-programmed computer system.

The illustrated example is provided for purposes of illustrating a computing environment which can be used to provide dedicated or private label cloud environments, for use by tenants of a cloud infrastructure in accessing subscription-based software products, services, or other offerings associated with the cloud infrastructure environment. In accordance with other embodiments, the various components, processes, and features described herein can be used with other types of cloud computing environments.

As illustrated in FIG. 1, in accordance with an embodiment, a cloud infrastructure or data analytics environment 100 can operate on a cloud computing infrastructure 101 comprising hardware (e.g., processor, memory), software resources, and one or more cloud interfaces 4 or other application program interfaces (API) that provide access to the shared cloud resources via one or more load balancers 6.

In accordance with an embodiment, the cloud infrastructure environment supports the use of availability domains, such as, for example, availability domains A 80, B 82, which enables customers to create and access cloud networks 84, 86, and run cloud instances A 92, B 94.

In accordance with an embodiment, a tenancy can be created for each cloud tenant/customer, for example tenant A 42, B 44, which provides a secure and isolated partition within the cloud infrastructure environment within which the customer can create, organize, and administer their cloud resources. A cloud tenant/customer can access an availability domain and a cloud network to access each of their cloud instances.

In accordance with an embodiment, a client device, such as, for example, a computing device 10 having a device hardware 11 (e.g., processor, memory), application 14 and graphical user interface 12, can enable an administrator other user to communicate with the cloud infrastructure environment via a network such as, for example, a wide area network, local area network, or the Internet, to create or update cloud services.

In accordance with an embodiment, the cloud infrastructure environment provides access to shared cloud resources 40 via, for example, a compute resources layer 50, a network resources layer 64, and/or a storage resources layer 70. Customers can launch cloud instances as needed, to meet compute and application requirements. After a customer provisions and launches a cloud instance, the provisioned cloud instance can be accessed from, for example, a client device.

In accordance with an embodiment, the compute resources layer can comprise resources, such as, for example, bare metal cloud instances 52, virtual machines 54, graphical processing unit (GPU) compute cloud instances 57, and/or containers 58. The compute resources layer can be used to, for example, provision and manage bare metal compute cloud instances, or provision cloud instances as needed to deploy and run applications, as in an on-premises data center.

For example, in accordance with an embodiment, the cloud infrastructure environment can provide control of physical host (bare metal) machines within the compute resources layer, which run as compute cloud instances directly on bare metal servers, without a hypervisor.

In accordance with an embodiment, the cloud infrastructure environment can also provide control of virtual machines within the compute resources layer, which can be launched, for example, from an image, wherein the types and quantities of resources available to a virtual machine cloud instance can be determined, for example, based upon the image that the virtual machine was launched from.

In accordance with an embodiment, the network resources layer can comprise a number of network-related resources, such as, for example, virtual cloud networks (VCNs) 65, load balancers 67, edge services 68, and/or connection services 69.

In accordance with an embodiment, the storage resources layer can comprise a number of resources, such as, for example, data/block volumes 72, file storage 74, object storage 76, and/or local storage 78.

In accordance with an embodiment, the cloud environment can include a container orchestration system, and container orchestration system API, that enables containerized application workflows to be deployed to a container orchestration environment, for example a Kubernetes (k8s) cluster.

For example, in accordance with an embodiment, the cloud environment can be used to provide containerized compute cloud instances within the compute resources layer, and a container orchestration implementation (e.g., Oracle Cloud Infrastructure Container Engine for Kubernetes (OKE)), can be used to build and launch containerized applications or cloud-native applications, specify compute resources that the containerized application requires, and provision the required compute resources.

As illustrated in FIG. 2, in accordance with an embodiment, the cloud infrastructure or data analytics environment can include a range of complementary cloud-based components, for example as cloud infrastructure applications and services 111, that enable organizations or enterprise customers to operate their applications and services in a highly-available hosted environment.

By way of example, in accordance with an embodiment, a self-contained cloud region can be provided as a complete, e.g., Oracle Cloud Infrastructure (OCI) dedicated region within an organization's data center that offers the data center operator the agility, scalability, and economics of a public cloud, while retaining full control of their data and applications to meet security, regulatory, or data residency requirements.

### Data Analytics Environments

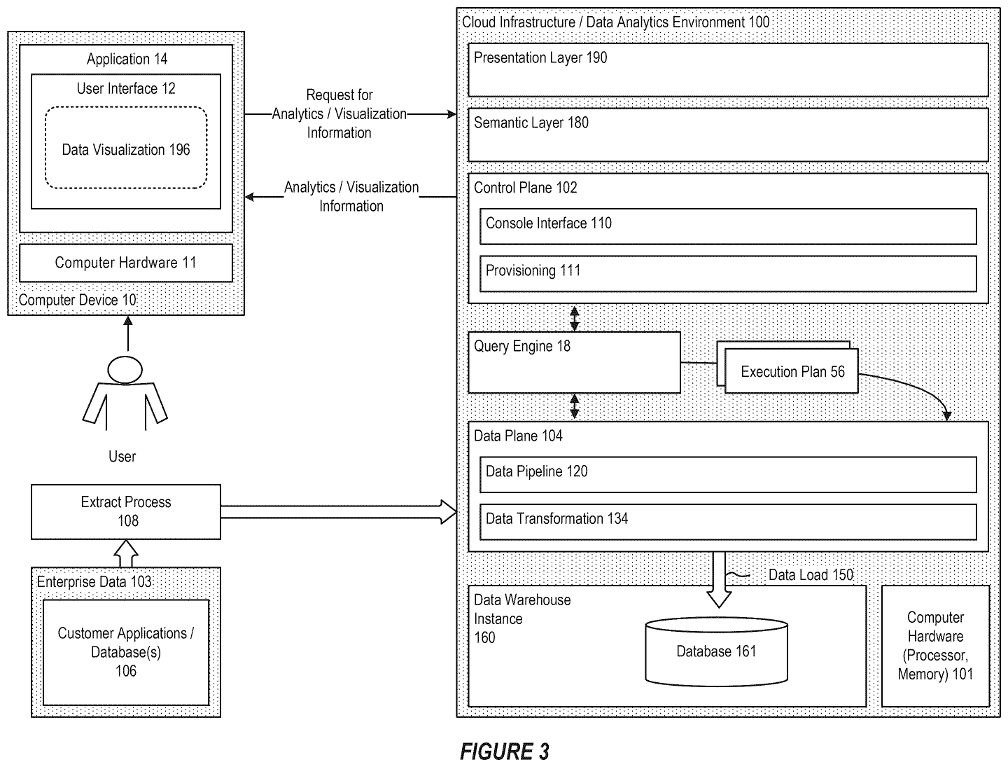

FIG. 3 illustrates an example use of the system to provide a data analytics environment, in accordance with an embodiment.

The example embodiment illustrated in FIG. 3 is provided for purposes of illustrating an example of a data analytics environment in association with which various embodiments described herein can be used. In accordance with other embodiments and examples, the approach described herein can be used with other types of data analytics, database, or data warehouse environments.

As illustrated in FIG. 3, in accordance with an embodiment, a data analytics environment 100 can be provided by, or otherwise operate at, a computer system having a computer hardware (e.g., processor, memory) 101, and including one or more software components operating as a control plane 102, and a data plane 104, and providing access in the manner of a data layer to a data warehouse instance 160 (e.g., having a database 161, or other type of data source).

In accordance with an embodiment, the control plane operates to provide control for cloud or other software products offered within the context of a cloud environment. For example, in accordance with an embodiment, the control plane can include a console interface 110 that enables access by a customer (tenant) and/or a cloud environment having a provisioning component 111, for example to allow customers to provision services for use within their enterprise environment. The provisioning component can provision a data warehouse instance, including a customer schema of the data warehouse; and populate the data warehouse instance with the appropriate information supplied by the customer.

In accordance with an embodiment, the data plane can include a data pipeline or process layer 120 and a data transformation layer 134, that together process data from an organization's enterprise software environment, and load a transformed data into the data warehouse. The data transformation layer can include a data model, such as, for example, a knowledge model (KM), or other type of data model, that the system uses to transform the data received from business applications and corresponding databases, into a model format understood by the data analytics environment. The data plane is responsible for performing extract, transform, and load (ETL) operations, including extracting data from an organization's enterprise software environment, transforming the extracted data into a model format, and loading the transformed data into a customer schema of the data warehouse.

For example, in accordance with an embodiment, each customer (tenant) of the environment can be associated with their own customer schema; and can be additionally provided with read-only access to the data analytics schema, which can be updated by a data pipeline or process, for example, an ETL process, on a periodic or other basis. For example, a data pipeline or process can be scheduled to execute at intervals (e.g., hourly/daily/weekly) to extract enterprise data 103 from an enterprise software environment, such as, for example, business productivity software applications and corresponding databases 106.

In accordance with an embodiment, an extract process 108 can extract the data, whereupon extraction the data pipeline or process can insert extracted data into a data staging area, which can act as a temporary staging area for the extracted data. When the extract process has completed its extraction, the data transformation layer can be used to transform the extracted data into a model format to be loaded into the customer schema of the data warehouse. During the data transformation, the system can perform dimension generation, fact generation, and aggregate generation, as appropriate. Dimension generation can include generating dimensions or fields for loading into the data warehouse instance.

In accordance with an embodiment, after transformation of the extracted data, the data pipeline or process can execute a warehouse load procedure 150, to load the transformed data into the customer schema of the data warehouse instance. Subsequent to the loading of the transformed data into customer schema, the transformed data can be analyzed and used in a variety of additional business intelligence processes.

Different customers may have different requirements with regard to how their data is classified, aggregated, or transformed, for providing data analytics or business intelligence data, or developing software analytic applications. In accordance with an embodiment, to support such different requirements, a semantic layer 180 can include data defining a semantic model of a customer's data; which is useful in assisting users in understanding and accessing that data using commonly-understood business terms; and provide custom content to a presentation layer 190.

In accordance with an embodiment, a customer may perform modifications to their data source model, to support their particular requirements, for example by adding custom facts or dimensions associated with the data stored in their data warehouse instance; and the system can extend the semantic model accordingly. A semantic model can be defined, for example, in an Oracle environment, as a BI Repository (RPD) file, having metadata that defines logical schemas, physical schemas, physical-to-logical mappings, aggregate table navigation, and/or other constructs that implement the various physical layer, business model and mapping layer, and presentation layer aspects of the semantic model.

In accordance with an embodiment, the presentation layer can enable access to the data content using, for example, a software analytic application, user interface, analytics dashboard, key performance indicators (KPI's); or other type of report or interface as may be provided by products such as, for example, Oracle Analytics Cloud, or Oracle Analytics for Applications.

In accordance with an embodiment, a query engine 18 (e.g., an Oracle Business Intelligence Server, OBIS instance) operates in the manner of a federated query engine to serve analytical queries or requests from clients directed to data stored at a database. The query engine can push down operations to supported databases, in accordance with a query execution plan 56, wherein a logical query can include Structured Query Language (SQL) statements received from the clients; while a physical query includes database-specific statements that the query engine sends to the database to retrieve data when processing the logical query.

In accordance with an embodiment, a user/developer can interact with a client computer device 10 that includes a computer hardware 11 (e.g., processor, storage, memory), user interface 12, and client application 14. A query engine or business intelligence server generally operates to process inbound, e.g., SQL, requests against a database model, build and execute one or more physical database queries, process the data appropriately, and return the data in response to the request.

To accomplish this, in accordance with an embodiment, the query engine can include a logical or business model, or metadata, that describes the data available as subject areas for queries; a request generator that takes incoming queries and turns them into physical queries for use with a connected data source; and a navigator that takes the incoming query, navigates the logical model and generates those physical queries that best return the data required for a particular query.

For example, in accordance with an embodiment, the query engine may employ a logical model mapped to data in a data warehouse, by creating a simplified star schema business model over various data sources so that the user can query data as if it originated at a single source. The information can then be returned to the presentation layer as subject areas, according to business model layer mapping rules.

In accordance with an embodiment, the query engine can process queries against a database according to a query execution plan. During operation the query engine can create a query execution plan which can then be further optimized, for example to perform aggregations of data necessary to respond to a request. Data can be combined together and further calculations applied, before the results are returned to the calling application.

In accordance with an embodiment, a request for data analytics or visualization information can be received via a client application and user interface as described above, and communicated to the data analytics environment (in the example of a cloud environment, via a cloud service). The system can retrieve an appropriate dataset to address the user/business context, for use in generating and returning the requested data analytics or visualization information to the client, as a data visualization 196.

In accordance with an embodiment, a client application can be implemented as software or computer-readable program code executable by a computer system or processing device, and having a user interface, such as, for example, a software application user interface or a web browser interface. The client application can retrieve or access data via an Internet/HTTP or other type of network connection to the data analytics environment, or in the example of a cloud environment via a cloud service provided by the environment.

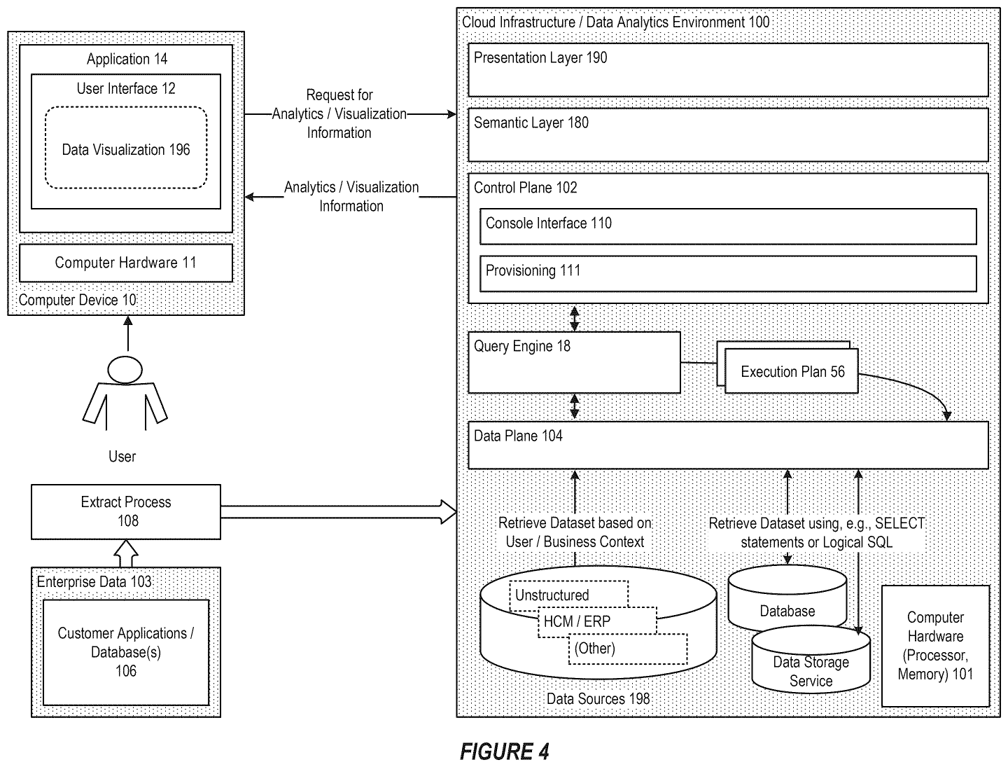

FIG. 4 further illustrates an example data analytics environment, in accordance with an embodiment.

As illustrated in FIG. 4, in accordance with an embodiment, the data analytics environment enables a dataset to be retrieved, received, or prepared from one or more data source(s) 198, for example via one or more data source connections. Examples of the types of data that can be transformed, analyzed, or visualized using the systems and methods described herein include data directed to Enterprise Resource Planning (ERP), Human Capital Management (HCM), or Human Resources (HR), or other types of data provided at one or more of a database, data storage service, or other type of data repository or data source.

For example, in accordance with an embodiment, a request for data analytics or visualization information can be received via a client application and user interface as described above, and communicated to the data analytics environment, for example via a cloud service. The system can retrieve an appropriate dataset to address the user/business context, for use in generating and returning the requested data analytics or visualization information to the client.

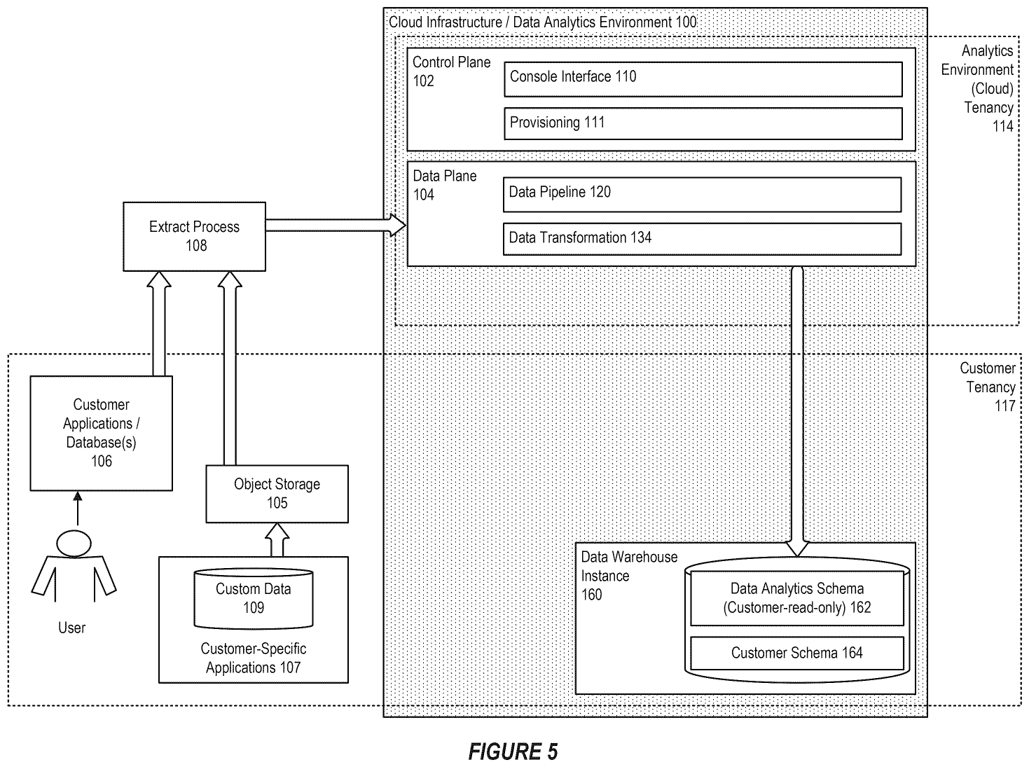

FIG. 5 further illustrates an example data analytics environment, in accordance with an embodiment.

As illustrated in FIG. 5, in accordance with an embodiment, data can be sourced, e.g., from a customer's (tenant's) enterprise software environment (106), using the data pipeline process; or as custom data 109 sourced from one or more customer-specific applications 107; and loaded to a data warehouse instance, including in some examples the use of an object storage 105 for storage of the data. A user can create a dataset that uses tables from different connections and schemas. The system uses the relationships defined between these tables to create relationships or joins in the dataset.

In accordance with an embodiment, the data warehouse can include a default data analytics schema 162 and, for each customer (tenant) of the system, a customer schema 164. For each customer (tenant), the system uses the data analytics schema that is maintained and updated by the system, within a system/cloud tenancy 114, to pre-populate a data warehouse instance for the customer, based on an analysis of the data within that customer's enterprise applications environment, and within a customer tenancy 117. As such, the data analytics schema maintained by the system enables data to be retrieved, by the data pipeline or process, from the customer's environment, and loaded to the customer's data warehouse instance.

In accordance with an embodiment, the system also provides, for each customer of the environment, a customer schema that allows the customer to supplement and utilize the data within their own data warehouse instance. For each customer, their resultant data warehouse instance operates as a database whose contents are partly-controlled by the customer; and partly-controlled by the environment (system).

For example, in accordance with an embodiment, a data warehouse can include a data analytics schema and, for each customer/tenant, a customer schema sourced from their enterprise software environment. The data provisioned in a data warehouse tenancy is accessible only to that tenant; while at the same time allowing access to various, e.g., ETL-related or other features of the shared environment.

In accordance with an embodiment, for a particular customer/tenant, upon extraction of their data, the data pipeline or process can insert the extracted data into a data staging area for the tenant, which can act as a temporary staging area for the extracted data. When the extract process has completed its extraction, the data transformation layer can be used to transform the extracted data into a model format to be loaded into the customer schema of the data warehouse.

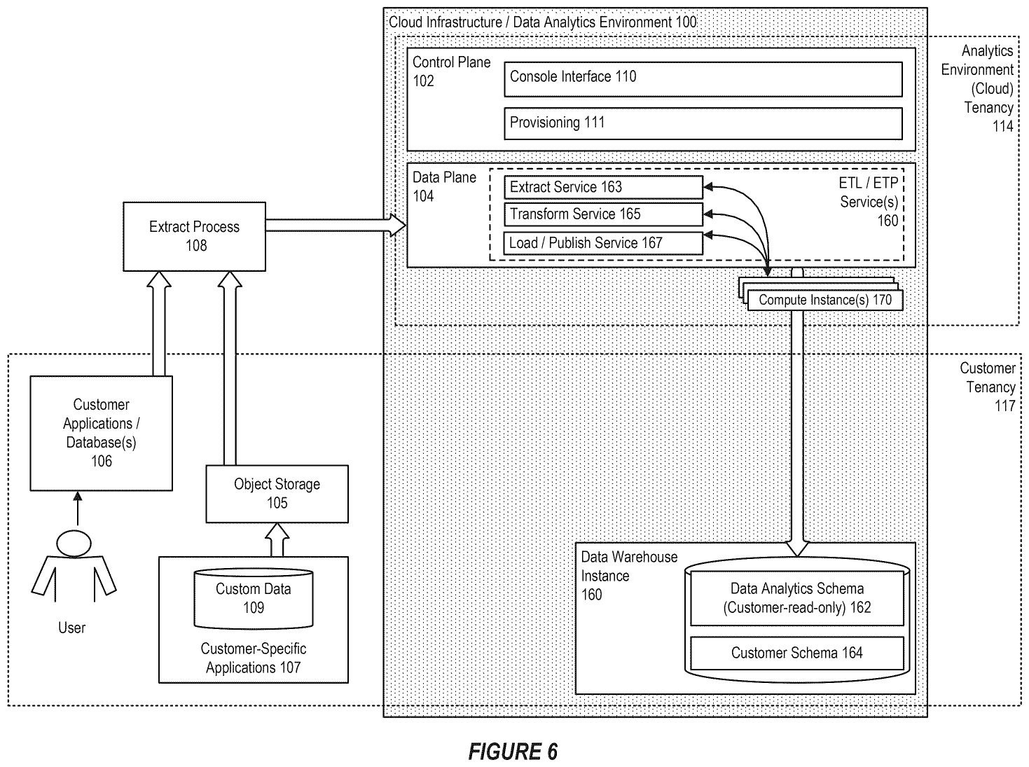

FIG. 6 further illustrates an example data analytics environment, in accordance with an embodiment.

As illustrated in FIG. 6, in accordance with an embodiment, the process of extracting data from a customer's (tenant's) enterprise software environment, and loading the data to a data warehouse instance, or refreshing the data in a data warehouse, generally involves several stages, performed by an ETP service 160 or process, including one or more extraction service 163; transformation service 165; and load/publish service 167, executed by one or more compute instance(s) 170.

For example, in accordance with an embodiment, extracted files can be uploaded to an object storage component for storage of the data. The transformation process then applies a business logic while loading them to a target data warehouse, e.g., an Autonomous Data Warehouse (ADW) database, which is internal to the data pipeline or process, and is not exposed to the customer (tenant). A load/publish service or process takes the data from the ADW database and publishes it to a data warehouse instance that is accessible to the customer (tenant).

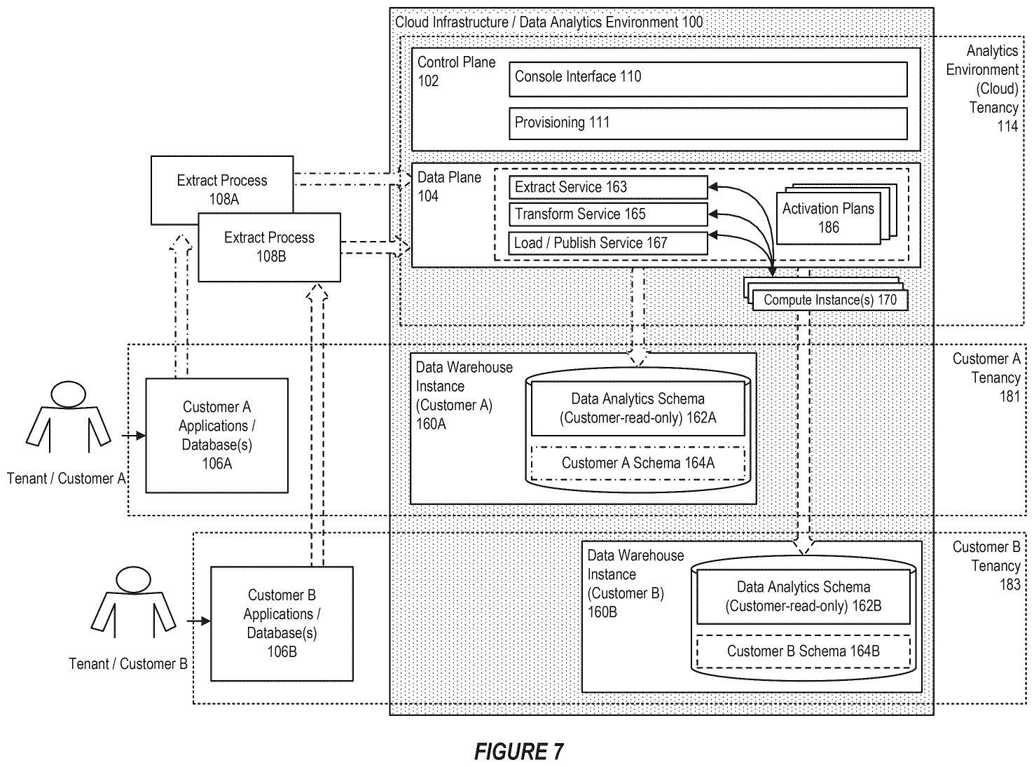

FIG. 7 further illustrates an example data analytics environment, in accordance with an embodiment.

As illustrated in FIG. 7, in accordance with an embodiment, the data pipeline or process maintains, for each of a plurality of customers (tenants), for example customer A 180, customer B 182, a data analytics schema that is updated on a periodic basis, by the system in accordance with best practices for a particular analytics use case. For each of a plurality of customers (e.g., customers A, B), the system uses the data analytics schema 162A, 162B, that is maintained and updated by the system, to pre-populate a data warehouse instance for the customer, based on an analysis of the data within that customer's enterprise applications environment 106A, 106B, and within each customer's tenancy (e.g., customer A tenancy 181, customer B tenancy 183); so that data is retrieved, by the data pipeline or process, from the customer's environment, and loaded to the customer's data warehouse instance 160A, 160B.

In accordance with an embodiment, the data analytics environment also provides, for each of a plurality of customers of the environment, a customer schema (e.g., customer A schema 164A, customer B schema 164B) that allows the customer to supplement and utilize the data within their own data warehouse instance.

As described above, in accordance with an embodiment, for each of a plurality of customers of the data analytics environment, their resultant data warehouse instance operates as a database whose contents are partly-controlled by the customer; and partly-controlled by the data analytics environment (system); including that their database appears pre-populated with appropriate data that has been retrieved from their enterprise applications environment to address various analytics use cases. When the extract process 108A, 108B for a particular customer has completed its extraction, the data transformation layer can be used to transform the extracted data into a model format to be loaded into the customer schema of the data warehouse.

In accordance with an embodiment, activation plans 186 can be used to control the operation of the data pipeline or process services for a customer, for a particular functional area, to address that customer's (tenant's) particular needs. For example, an activation plan can define a number of extract, transform, and load (publish) services or steps to be run in a certain order, at a certain time of day, and within a certain window of time.

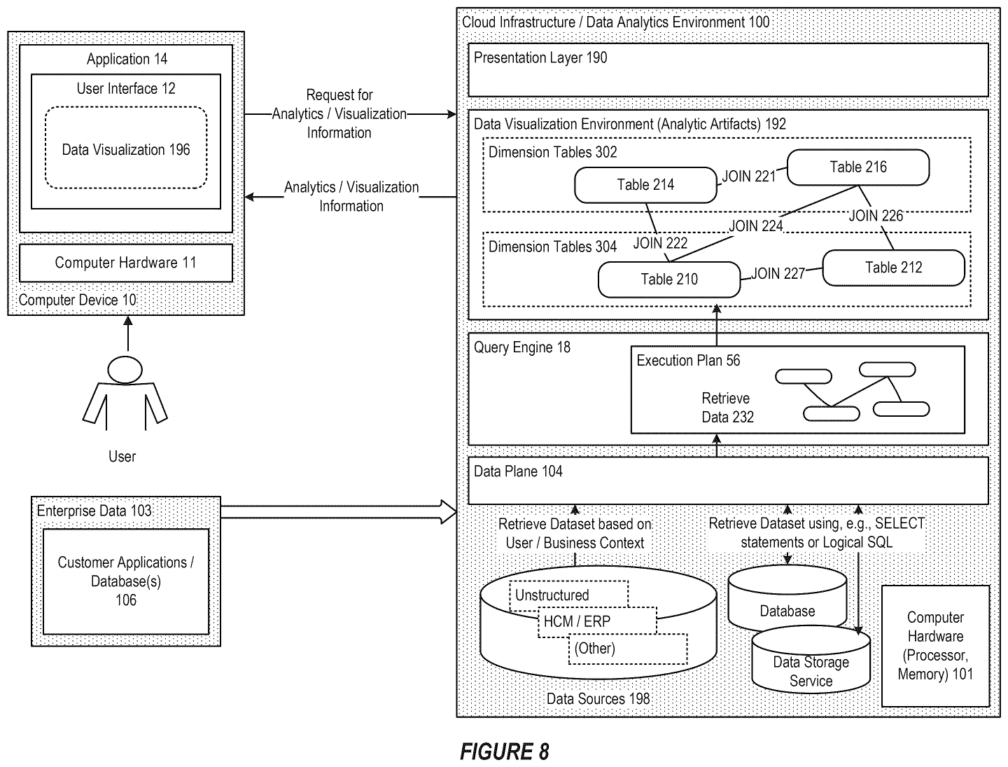

FIG. 8 further illustrates an example data analytics environment, in accordance with an embodiment.

Generally described, within a database or data warehouse, the data of interest may be spread across multiple tables. In such environments, joins can be used to stitch the data from various tables together, to better prepare the data for analysis.

For example, as illustrated in FIG. 8, in accordance with an embodiment, the data analytics environment enables a dataset to be retrieved, received, or prepared from one or more data source(s), for example via one or more data source connections, fact and/or dimension tables 210-216, or joins 221-227 between selections of dimension tables 302, 304.

In accordance with an embodiment, a request received at a data visualization environment to display analytic artifacts 192, for example as may be related to key performance indicators, analytics dashboards, or scorecards, can be received via a client application and user interface as described above, and communicated to the data analytics environment via a cloud service. The system can retrieve 232 an appropriate dataset using, e.g., SELECT statements, to address the user/business context, for use in generating and returning the requested data analytics or visualization information to the client.

### Large Language Models (LLM)

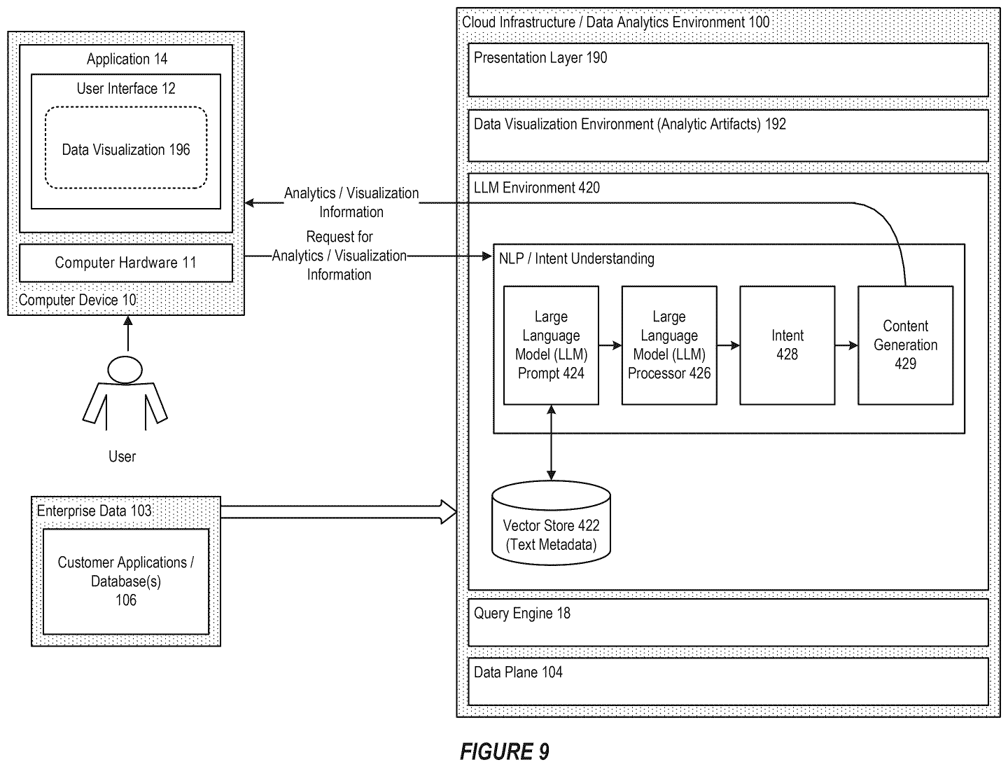

FIG. 9 further illustrates an example data analytics environment, including the use of a large language model, in accordance with an embodiment.

As illustrated in FIG. 9, in accordance with an embodiment, a data analytics system can include a large language model (LLM) environment 420. A vector database 422 provides storage and retrieval of vectors or vector embeddings, which in turn enables LLMs to understand information with increased context and accuracy, for example in generating a requested data analytics information or data visualization.

In accordance with an embodiment, the system can parse a user query or natural language input, infer an intent 428 based on one or more large language model (LLM) prompt 424 or LLM processor 426, and then determine, for example, which subject areas may be relevant to the inferred intent, and generate or return an appropriate content 429.

### Retrieval-augmented Generation (RAG)

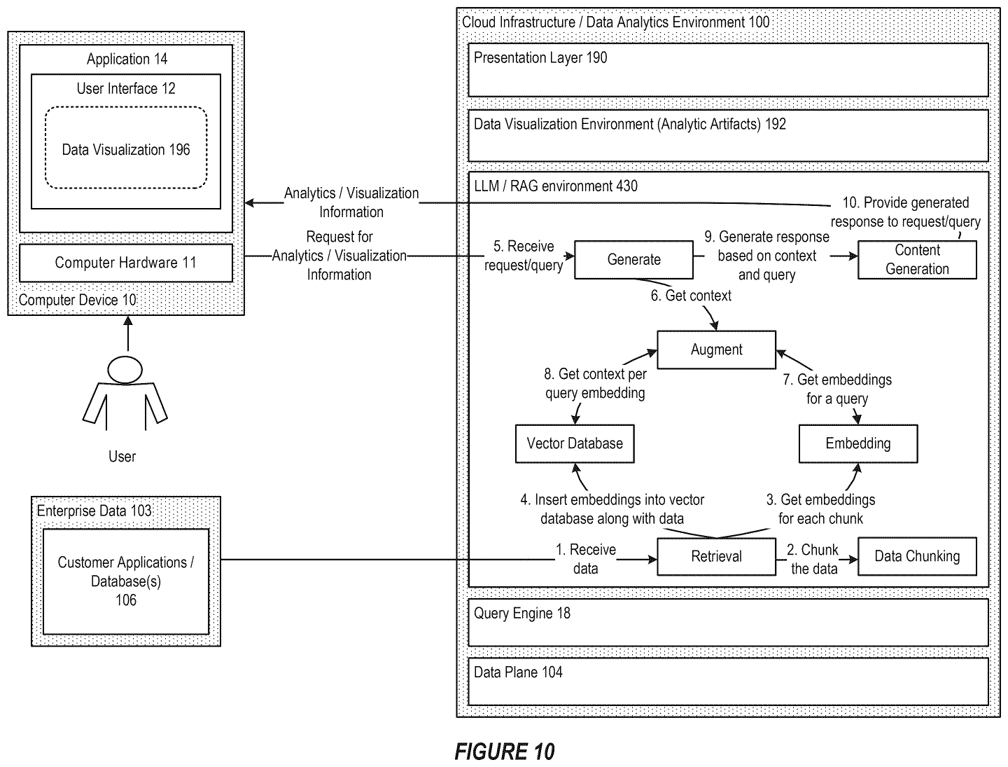

FIG. 10 further illustrates an example data analytics environment, including the use of retrieval-augmented generation, in accordance with an embodiment.

As illustrated in FIG. 10, in accordance with an embodiment, a data analytics system can include the use of retrieval-augmented generation (RAG) environment 430 that optimizes the output of a large language model (LLM) with targeted information, to provide a more contextually appropriate content in response to a user query.

In accordance with an embodiment, during the retrieval process:

Enterprise data can be received (1) in various formats, for example, as PDF, TXT, CSV, XML, or JSON documents, via REST, File, or other protocols.

The enterprise data or documents is broken into a plurality of segment or chunks (2).

Vector embeddings are obtained for each chunk of data (3), for example by calling a generative AI embedding service, or by using an embedding model.

The vector embeddings associated with the chunks of data are stored in a vector database, along with the data (4).

In accordance with an embodiment, during the augmented generation process:

The system can receive from a user, a data request or query, or a natural language input (5).

The system invokes an augmentation process or service to obtain the context for the request or query (6).

An embedding service is used to get the vector embeddings of the query data (7).

The augmentation process or service can obtain additional context based on a semantic search of the query data and its vector embedding (8).

The system can then generate an appropriate response based on the context and query (9); and return the generated response to the user (10).

The above example is provided for purpose of illustrating an example of a data analytics environment that includes the use of retrieval-augmented generation. In accordance with other embodiments, the system can include other forms of retrieval-augmented generation, which in turn can include different or other components or processes.

### AI-Based Assistant for use in Software Development

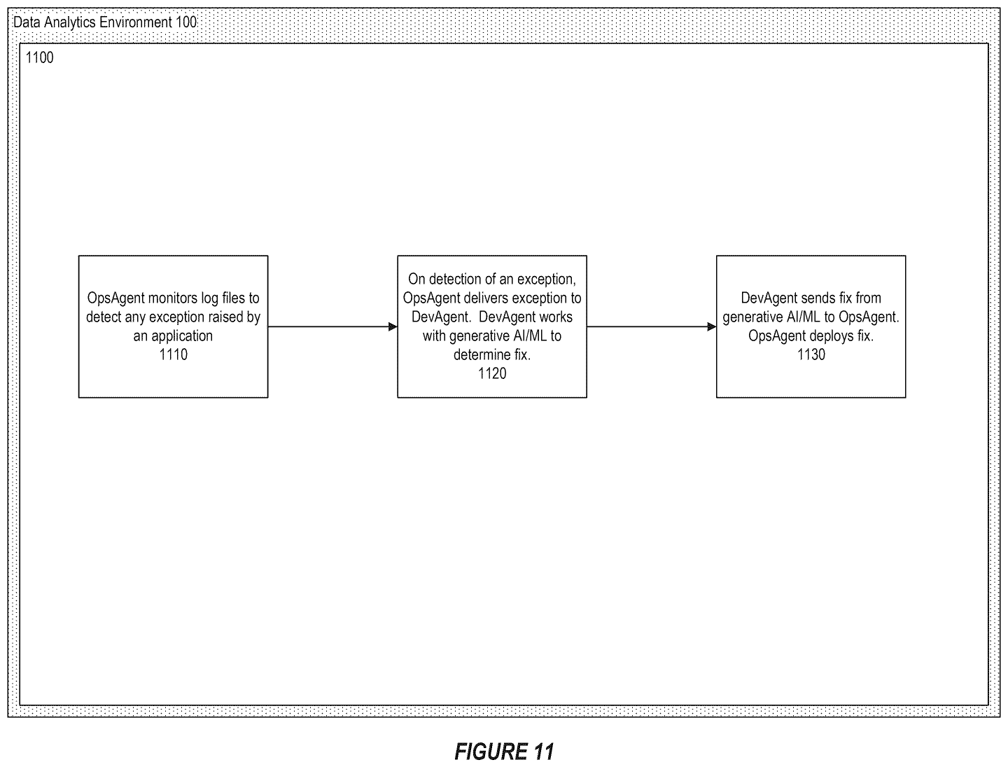

FIG. 11 illustrates a flowchart for use with a data analytics environment to provide an AI-based assistant for use in software development, in accordance with an embodiment.

In accordance with an embodiment, FIG. 11 illustrates a simplified flowchart of a method for use with a data analytics environment to provide an AI-based assistant for use in software development.

In accordance with an embodiment, within an environment 1100 of a data analytics environment 100, a flow can begin at 1110 with a first agent, such as an operations agent (OpsAgent), continuously monitoring log files to detect any exception and/or error raised by an application.

In accordance with an embodiment, at 1120, the flow can, on detection of an exception and/or error by the OpsAgent, deliver, by the OpsAgent, the exception and/or error to a second agent, or development agent (DevAgent). The DevAgent can work with a generative AI/ML to determine and generate a fix for the detected exception and/or error.

In accordance with an embodiment, at 1130, the flow can send, by the DevAgent, the generated fix to the OpsAgent. The OpsAgent can then deploy the fix to, for example, an application server.

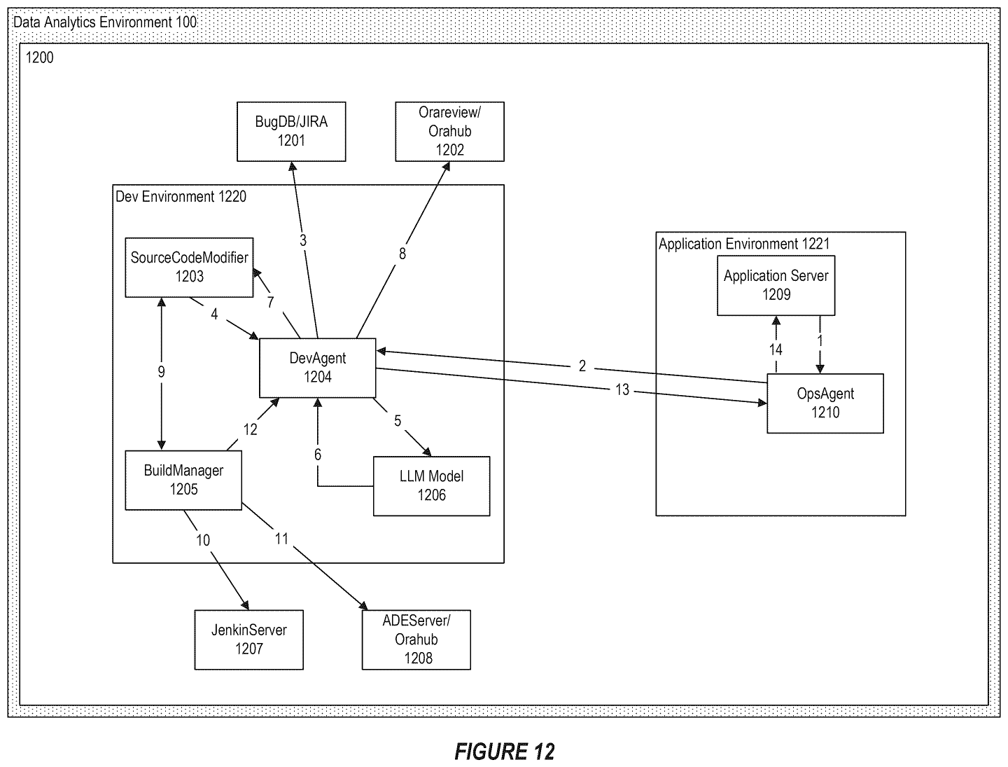

FIG. 12 illustrates a system for use with a data analytics environment to provide an AI-based assistant for use in software development, in accordance with an embodiment.

In accordance with an embodiment, generally, to address and fix software bugs, a developer needs to check the error logs and make the fixes to a code; then follow the development cycle of sending for updated/fixed code review; get approval and merge the code; then build and deploy the fix in an application server.

In accordance with an embodiment, the described approach can be used to make this process automatic with AI/ML agents working together. Instead of a developer performing the code fix and deploying the fix manually in server, the system can utilize an AI-based approach where everything is performed automatically using AI/ML tools and models.

In accordance with an embodiment, an agent, such as an OpsAgent, can monitor (e.g., continuously) logs of the application. Once an error is noticed in the log file by the OpsAgent, the agent can analyze the log message, create an issue and contact another agent, such as a DevAgent. The DevAgent agent can generate the code fix and send the fix to the OpsAgent. The OpsAgent can deploy the fix in the server. Finally, the application server is restarted.

in Accordance with an embodiment, FIG. 12 illustrates a process flow within an environment 1200 within a data analytics environment 100.

In accordance with an embodiment, at an application environment 1221, at 1, the OpsAgent 1210 continuously monitors logs created by applications running via the application server 1209 to check if any error or exception occurred.

In accordance with an embodiment, at 2, upon the OpsAgent detecting any error or exception in logs, the OpsAgent can contact a DevAgent 1204 within the development environment (Dev Environment) 1220 by sending the error message or exception from log file by a service, such as a web service Call.

In accordance with an embodiment, at 3, the DevAgent, on notification or receiving the error message or exception, can create, e.g., a Jira/Bug 1201 ticket with received error message or exception.

In accordance with an embodiment, at 4, the DevAgent can receive the code related to error message from the source code modifier (SourceCodeModifier) 1203. For example, if an error is detected when running an HR Application at the Application Server, then the DevAgent can receive code related to the HR Application.

In accordance with an embodiment, at 5, the DevAgent can send the code along with error message to LLM model 1206. In accordance with an embodiment, the DevAgent can select one or more LLM models to utilize depending on the error message as well as the code to be relayed to the LLM model. For example, if the error message was related to an error thrown by an HR Application, the DevAgent can select an LLM model that has historically had good results with generating fixes for HR Applications. If the error message had to do with an application running away with memory, then the DevAgent can select another LLM model to utilize for generating a code fix for the error.

In accordance with an embodiment, at 6, the LLM model generates updates/fixes to the code with a fix and sends back to DevAgent.

In accordance with an embodiment, at 7, the DevAgent can then send the LLM generated/suggested code to a module, such as SourceCodeModifier, which then updates original code according to the generated/suggested fix.

In accordance with an embodiment, at 8, the DevAgent creates a code review request at a module (e.g., Orahub) 1202, for the modified code from SourceCodeModifier. This code review request can comprise a manual hook configured for approval. When such a manual hook is configured, developers need to review the code changes and approve the changes. If the developer does not agree with changes made by the AI/ML tool, the developer can open the transaction created by the AI tool, make changes and send them for review again. Alternatively, when a manual hook is not configured, the code review can be automatically approved.

In accordance with an embodiment, at 9, once code review is approved, a build manager (BuildManager) 1205 can build the source code. The BuildManager can trigger the preflight (running the test suite for the project). If preflight tests are failing, the DevAgent can go back to 5 and make another version of code change. The system can configure how many times the agent will repeat this.

In accordance with an embodiment, at 10, after getting successful preflight results, the BuildManager will send the Merge Request to a server, such as a Jenkins server (JenkinServer) 1207. The merge request can be auto approved by default (it can alternatively be configured to make manual approval).

In accordance with an embodiment, at 11, after the merge request is approved, the BuildManager will generate the binaries at Orahub 1208.

In accordance with an embodiment, at 12, the BuildManager can, after the binaries have been generated, deliver the generated binaries to the DevAgent.

In accordance with an embodiment, at 13, the DevAgent can send the binaries to the OpsAgent via a web service call.

In accordance with an embodiment, at 14, the OpsAgent can deploy the binaries and restart the Application Server.

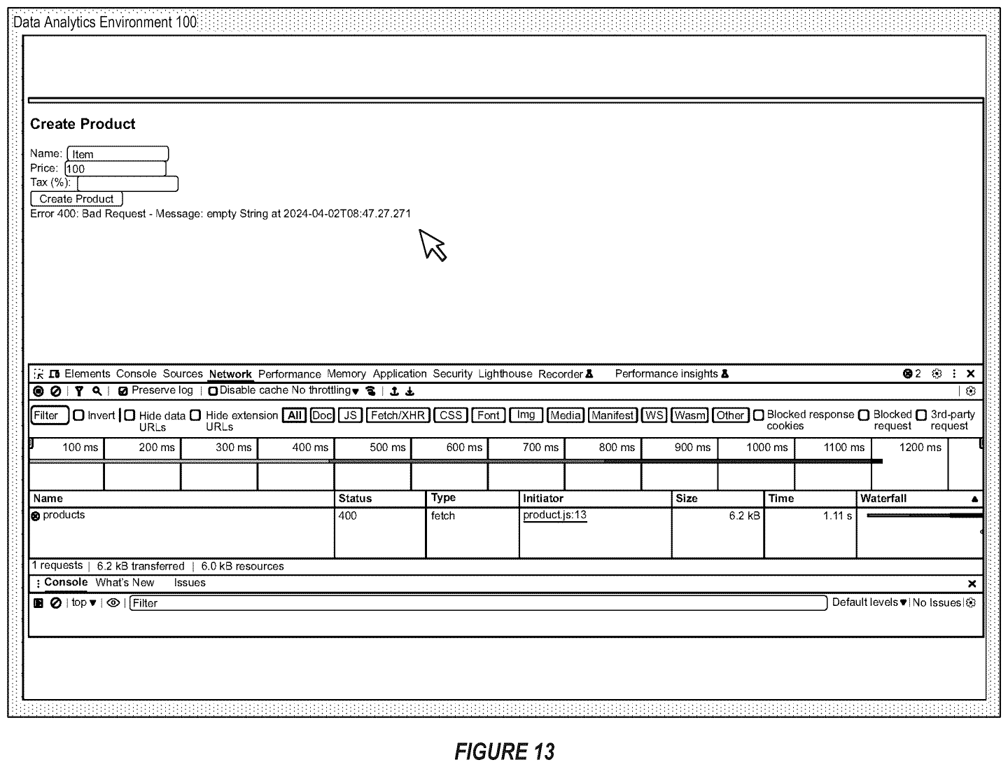

FIG. 13 illustrates a screenshot produced by a system for use with a data analytics environment to provide an AI-based assistant for use in software development, in accordance with an embodiment.

In accordance with an embodiment, FIG. 13 depicts a coding screen where a code is being generated to “Create Product” where inputs are name, price and tax percentage. Initially, the tax percentage is left blank, which results in an error message “empty string” as shown in FIG. 13.

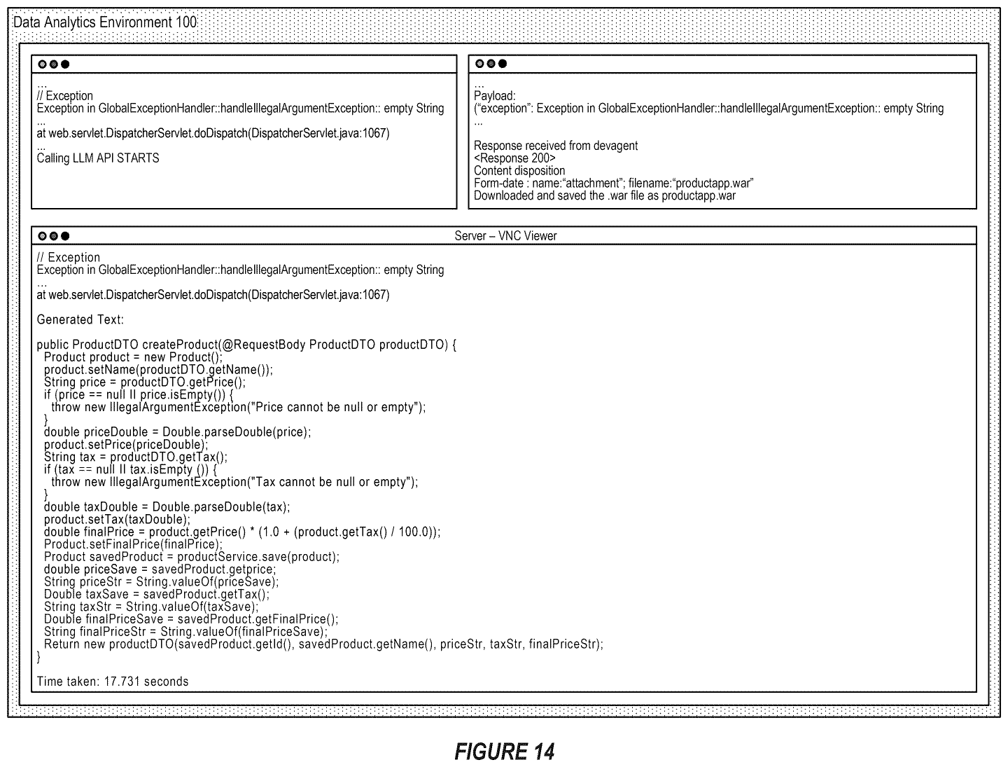

FIG. 14 illustrates a screenshot produced by a system for use with a data analytics environment to provide an AI-based assistant for use in software development, in accordance with an embodiment.

In accordance with an embodiment, FIG. 14 depicts an AI-based assistant utilizing an LLM for code development for the “Create Product” code.

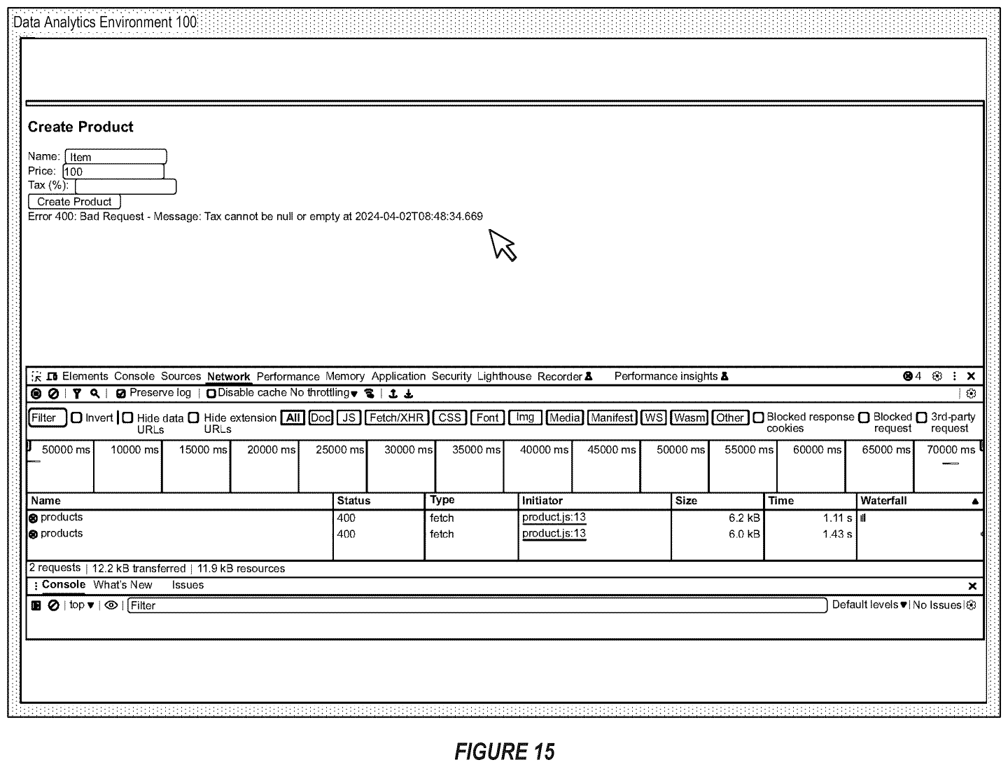

FIG. 15 illustrates a screenshot produced by a system for use with a data analytics environment to provide an AI-based assistant for use in software development, in accordance with an embodiment.

In accordance with an embodiment, FIG. 15 depicts a coding screen where a code is being generated to “Create Product” where inputs are name, price and tax percentage. After the AI-based assistant has run processed the initially produced code with an LLM, the tax percentage is left blank, which results in an error message “Tax cannot be null or empty” as shown in FIG. 15.

In accordance with an embodiment, code bugs across the products can be fixed by the AI Agents without developer involvement, saving time and money spent on fixing the bugs. The speed efficiency of the end-to-end pipeline allows for relatively low waiting by the user to get the results back.

In accordance with an embodiment, the described approach provides a process flow in which different AI Agents will work together to do a code fix and deploy the changes in the web server. Agents can interact with different tools like Github, Tomcat, LLM model, or Gradle, used by the Developer while building large enterprise application. An AI Agent will do its defined expected role and collaborate with the other agents from start of identifying the issue to the deployment of the auto-generated fix using generative AI LLM model. The whole process is automated and requires no manual intervention.

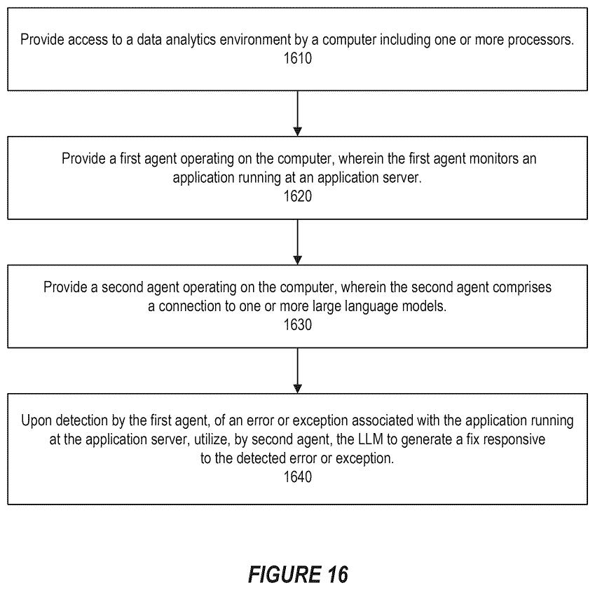

FIG. 16 illustrates a flowchart of a method for use with a data analytics environment to provide an AI-based assistant for use in software development, in accordance with an embodiment.

In accordance with an embodiment, at step 1610, the method can provide access to a data analytics environment by a computer including one or more processors.

In accordance with an embodiment, at step 1620, the method can provide a first agent operating on the computer, wherein the first agent monitors an application running at an application server.

In accordance with an embodiment, at step 1630, the method can provide a second agent operating on the computer, wherein the second agent comprises a connection to one or more large language models.

In accordance with an embodiment, at step 1640, upon detection by the first agent, of an error or exception associated with the application running at the application server, the method can utilize, by the second agent, the LLM to generate a fix responsive to the detected error or exception.

In accordance with an embodiment, the method can communicate, by the first agent, to the second agent an indication of the error or exception via a web service.

In accordance with an embodiment, the method can, upon receiving the indication of the error or exception from the first agent, receive, by the second agent, all or a portion of source code associated with the error or exception.

In accordance with an embodiment, the method can, upon receiving the indication of the error or exception, determine, by the second agent, a large language model of the one or more large language models based upon the indication of the error or exception. The method can also communicate, by the second agent, to the determined large language model the all or the portion of the source code associated with the error or exception.

In accordance with an embodiment, the method can receive, by the second agent, from the determined large language model the generated fix responsive to the detected error or exception.

In accordance with an embodiment, based upon the generated fix responsive for the detected error or exception, a new code can be built and checked.

In accordance with an embodiment, the second agent can communicate to the first agent the new code, and the first agent can deploy to the application server the new code.

In accordance with various embodiments, the systems and methods described herein can be implemented using one or more computer, computing device, machine, or microprocessor, including one or more processors, memory and/or computer readable storage media programmed according to the teachings of the present disclosure. Appropriate software coding can readily be prepared by skilled programmers based on the teachings of the present disclosure, as will be apparent to those skilled in the software art.

In some embodiments, the teachings herein can include a computer program product which is a non-transitory computer readable storage medium (media) having instructions stored thereon/in which can be used to program a computer to perform any of the processes of the present teachings. Examples of such storage mediums can include, but are not limited to, hard disk drives, hard disks, hard drives, fixed disks, ROMs, RAMs, EPROMs, EEPROMs, DRAMs, VRAMs, flash memory devices, or other types of storage media or devices suitable for non-transitory storage of instructions and/or data.

The foregoing description has been provided for the purposes of illustration and description. It is not intended to be exhaustive or to limit the scope of protection to the precise forms disclosed. Many modifications and variations will be apparent to the practitioner skilled in the art. For example, although several of the examples provided herein illustrate use with cloud environments such as Oracle Analytics Cloud; in accordance with various embodiments, the systems and methods described herein can be used with other types of enterprise software applications, cloud environments, cloud services, cloud computing, or other computing environments.

The embodiments were chosen and described in order to best explain the principles of the present teachings and their practical application, thereby enabling others skilled in the art to understand the various embodiments and with various modifications that are suited to the particular use contemplated. It is intended that the scope be defined by the following claims and their equivalents.

What is claimed is:

1. A system for use with a data analytics environment to provide an AI-based assistant for use in software development, comprising:
a computer including one or more processors, that provides access to a data analytics environment; and
a first agent operating on the computer, wherein the first agent monitors an application running at an application server;
a second agent operating on the computer, wherein the second agent comprises a connection to one or more large language models;
wherein upon detection, by the first agent, of an error or exception associated with the application running at the application server, the second agent utilizes the LLM to generate a fix responsive to the detected error or exception.

2. The system of claim 1,
wherein the first agent communicates to the second agent an indication of the error or exception via a web service.

3. The system of claim 2,
wherein, upon receiving the indication of the error or exception from the first agent, the second agent receives all or a portion of source code associated with the error or exception.

4. The system of claim 3,
wherein, upon receiving the indication of the error or exception, the second agent determines a large language model of the one or more large language models based upon the indication of the error or exception; and
wherein the second agent communicates to the determined large language model the all or the portion of the source code associated with the error or exception.

5. The system of claim 4,
wherein the second agent receives from the determined large language model the generated fix responsive to the detected error or exception.

6. The system of claim 5,
wherein, based upon the generated fix responsive for the detected error or exception, a new code is built and checked.

7. The system of claim 6,
wherein the second agent communicates to the first agent the new code; and
wherein the first agent deploys to the application server the new code.

8. A method for use with a data analytics environment to provide an AI-based assistant for use in software development, comprising:
providing access to a data analytics environment by a computer including one or more processors;
providing a first agent operating on the computer, wherein the first agent monitors an application running at an application server;
providing a second agent operating on the computer, wherein the second agent comprises a connection to one or more large language models;
upon detection, by the first agent, of an error or exception associated with the application running at the application server, utilizing, by second agent, the LLM to generate a fix responsive to the detected error or exception.

9. The method of claim 8, further comprising:
communicating, by the first agent, to the second agent an indication of the error or exception via a web service.

10. The method of claim 9, further comprising:
upon receiving the indication of the error or exception from the first agent, receiving, by the second agent, all or a portion of source code associated with the error or exception.

11. The method of claim 10, further comprising:
upon receiving the indication of the error or exception, determining, by the second agent, a large language model of the one or more large language models based upon the indication of the error or exception; and
communicating, by the second agent, to the determined large language model the all or the portion of the source code associated with the error or exception.

12. The method of claim 11, further comprising:
receiving, by the second agent, from the determined large language model the generated fix responsive to the detected error or exception.

13. The method of claim 12,
wherein, based upon the generated fix responsive for the detected error or exception, a new code is built and checked.

14. The method of claim 13,
wherein the second agent communicates to the first agent the new code; and
wherein the first agent deploys to the application server the new code.

15. A non-transitory computer readable storage medium having instructions thereon for use with a data analytics environment to provide an AI-based assistant for use in software development, which when read and executed, cause a computer to perform steps comprising:
providing access to a data analytics environment by the computer, the computer including one or more processors;
providing a first agent operating on the computer, wherein the first agent monitors an application running at an application server;
providing a second agent operating on the computer, wherein the second agent comprises a connection to one or more large language models;
upon detection, by the first agent, of an error or exception associated with the application running at the application server, utilizing, by second agent, the LLM to generate a fix responsive to the detected error or exception.

16. The non-transitory computer readable storage medium of claim 15, the steps further comprising:
communicating, by the first agent, to the second agent an indication of the error or exception via a web service.

17. The non-transitory computer readable storage medium of claim 16, the steps further comprising:
upon receiving the indication of the error or exception from the first agent, receiving, by the second agent, all or a portion of source code associated with the error or exception.

18. The non-transitory computer readable storage medium of claim 17, the steps further comprising:
upon receiving the indication of the error or exception, determining, by the second agent, a large language model of the one or more large language models based upon the indication of the error or exception; and
communicating, by the second agent, to the determined large language model the all or the portion of the source code associated with the error or exception.

19. The non-transitory computer readable storage medium of claim 18, the steps further comprising:
receiving, by the second agent, from the determined large language model the generated fix responsive to the detected error or exception.

20. The non-transitory computer readable storage medium of claim 19,
wherein, based upon the generated fix responsive for the detected error or exception, a new code is built and checked;
wherein the second agent communicates to the first agent the new code; and
wherein the first agent deploys to the application server the new code.
